(19) United States
(12) Patent Application Publication
(10) Pub. No.: US 2009/0106663 A1
(43) Pub. Date: Apr. 23, 2009

(54) CONTENT-TRIGGERED CUSTOMIZATIONS FOR MOBILE CLIENTS

(75) Inventors: Michael Pirie, Redmond, WA (US); Charles Grattan Lindsey, III, Redmond, WA (US); Harold A. Little, II, Seattle, WA (US); Gamze Seckin, Bellevue, WA (US)

Correspondence Address: SCHWABE, WILLIAMSON & WYATT, P.C., 1420 FIFTH, SUITE 3010, SEATTLE, WA, 98101, US

(73) Assignee: Vidiator Enterprises, Inc., Bellevue, WA (US)

(21) Appl. No.: 12/239,675

(22) Filed: Sep. 26, 2008

Related U.S. Application Data
(60) Provisional application No. 60/975,638, filed on Sep. 27, 2007.

(51) Int. Cl. G06F 3/048

(52) U.S. Cl. 715/744

(57) ABSTRACT

Systems and methods for presenting content by a mobile client device having a media player and an associated graphical end user interface. The system and method includes customizing the associated graphical end user interface based on the content to be presented, and presenting the content using the customized graphical end user interface. In one embodiment, the customizing may be triggered by one or more descriptors generated for the content. Examples of descriptors include content type or content metadata such as but not limited to a specific performer, type of performer, content owner or theme.

### RELATED APPLICATIONS

The present application claims priority to U.S. Provisional Application 60/975,638, entitled “CONTENT-TRIGGERED ADAPTATIONS FOR MOBILE CLIENTS”, filed on Sep. 27, 2007. The specification of the 60/975,638 provisional application is hereby fully incorporated by reference.

### FIELD

Embodiments of the present invention relate generally to the field of data processing. More specifically, embodiments of the present invention relate to apparatuses and methods associated with customizing a graphical user interface of a player of a mobile client device, based on content to be presented by the mobile client device.

### BACKGROUND

A mobile client device typically includes a player for presenting content on the mobile client device. In addition to presenting content, the player may also present various advertisements, user controls, or skins as part of a graphical user interface of the player. A skin may include, for example, a collection of display screen elements that together provide a particular “look and feel.” A skin, as well as advertisements, or user control configurations may be adapted or customized. Today, such customization is usually accomplished through a push/pull model. For example, a content provider often pushes content to the mobile client device, which in response, may manually demand or retrieve particular advertisements, skins, etc. to enhance the content. In the alternative, the content provider simply pushes customized advertisements, skins, etc. to the mobile client device along with the content. In another example, no exchange of advertisements or skins between the content provider and the mobile client device takes place, but various display screen elements may be manually customized at the mobile client device based on parameters set by a user of the mobile client device.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of a system of the invention, according to various embodiments;

FIG. 2 illustrates a flow diagram of interactions of a mobile client device in accordance with an embodiment of the invention;

FIG. 3 illustrates an exemplary flow of content and graphical user interface characteristics between a content provider system and a mobile client device, in accordance with an embodiment of the invention; and

FIG. 4 illustrates an exemplary content provider server, in accordance with an embodiment of the invention.

### DETAILED DESCRIPTION OF ILLUSTRATIVE EMBODIMENTS OF THE INVENTION

Illustrative embodiments of the present invention include but are not limited to a customization of a graphical end user interface (“graphical user interface”) associated with a media player of a mobile client device for presenting content on a mobile client device (hereinafter, may also be simply, mobile device). In various embodiments, a plurality of descriptors may be generated for content to be presented that may serve as triggers for one or more customization rules that specify certain adaptations or customizations to be made to the graphical user interface of a player of the mobile client device. In various embodiments, the mobile client device, content provider, or a service provider, may customize the skins, user controls, advertisements, and/or other components of the graphical user interface of the player.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. The term “mobile client device” or “mobile device” may be considered to be synonymous with portable device, however the term does not include devices affixed to a movable platform, e.g. dash mounted radio or CD player in an automobile. The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

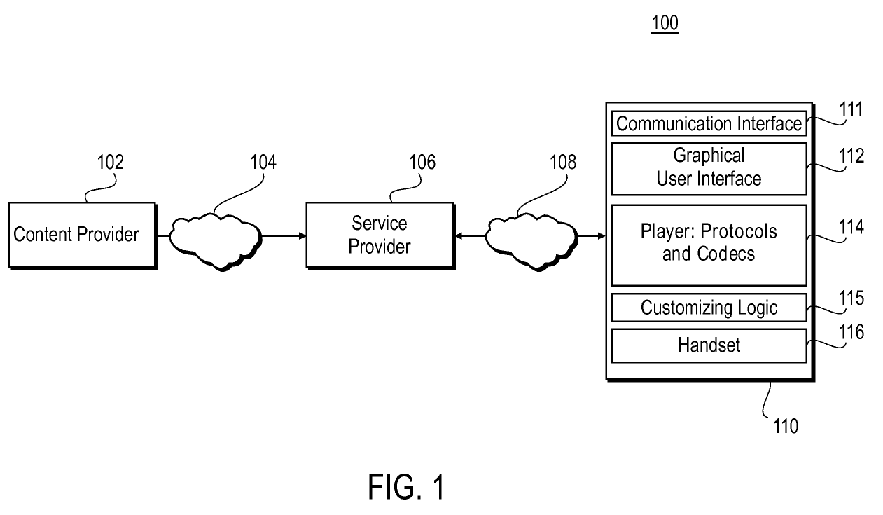

FIG. 1 illustrates an overview of a system 100, according to various embodiments of the present invention. As shown, a content provider 102 may provide content to a mobile client device 110 through an operator/carrier or service provider 106. Content provider 102 may be connected to service provider 106 via a networking fabric 104, and in turn, service provider 106 may be connected to mobile client device 110 through a networking fabric 108. Networking fabrics 104 and 108 may be any sort of networking fabrics known in the art. In one embodiment, they may even be the same networking fabric. Note that content provider 102 of FIG. 1 may create and/or distribute content, such as, for example, pictures, text, audio content, video content, and/or other multi-media content. Such content may be included in, (or accompanied by) for example, web pages, videos, or songs.

As shown, mobile client device 110 may include a communications interface 111, graphical user interface 112, a media player or player 114, a customizing logic 115, and a handset 116. Communications interface 111 may include components to enable Radio Frequency (RF) or other wireless communications, such as a cellular telephone network, Bluetooth connection, Mobile WiMax, or a wireless local or wide area network. Graphical user interface 112 may include any suitable graphical user interface that allows a user to interact with the mobile client device 110 and may include, for example, one or more of skins, user controls, and/or advertisements incorporated into the graphical user interface 112. In an embodiment, mobile client device 110 may receive content from a content provider 102, and then adapt or customize the graphical user interface 112 based at least in part on the content received. In an embodiment, communications interface 111 may be configured to receive the content via a selected one of an access point or a base station.

As will be discussed further, in various embodiments, the mobile client device 110 may also analyze the content, generate a plurality of descriptors about the content based on the analysis and then apply one or more customization rules to customize the graphical user interface 112 based on the descriptors. The mobile client device 110 can then present the content by player 114 which is configured to present content using the customized graphical user interface 112. Note also that mobile client device 110 may include a handset 116, which may include all or a portion of mobile client device 110.

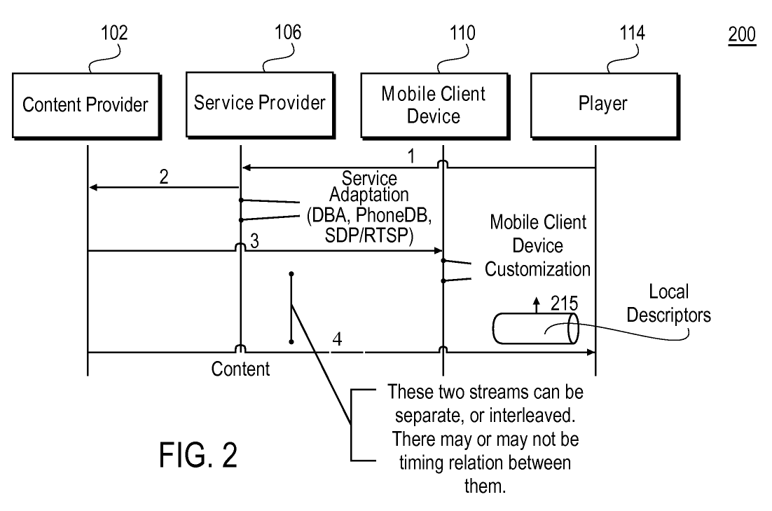

FIG. 2 is a flow diagram 200 illustrating interactions among content provider 102, service provider 106, mobile client device 110, and player 114 (included on mobile client device 110 as shown in FIG. 1), in accordance with an embodiment of the invention. Moving from the right to the left, a first indicator arrow represents a flow of information 1 transmitted from player 114 to service provider 106 via a communications infrastructure e.g. networking fabrics 104 and 108 of FIG. 1. Note that networking fabrics 104 and 108 may be, for example, one or more of a wide area network (WAN), a local area network (LAN), and the Internet. Thus, content provider 102 and service provider 106 may communicate via networking fabric 104, and service provider 106 and mobile client device 110 may communicate via networking fabric 108, and each may further use any communication protocol known in the art, such as the Hypertext Transfer Protocol (HTTP), and any transport protocol known in the art, such as the Transmission Control Protocol/Internet Protocol (TCP/IP) suite of protocols. Networking fabrics 104 and 108 may each be entirely or partially wired or wireless. Note that in the embodiment shown, service provider 106 may include a server and a plurality of access points or base stations for establishing wireless connections. In one embodiment, service provider 106 may provide wireless communication services to handset 116 of mobile client device 110, and may be associated with a wireless service provider, such as, for example, Verizon or Sprint.

In the embodiment shown, the flow of information 1 transmitted from player 114 to service provider 106 may be based on parameters related to the player 114. For example, in various embodiments, player 114, including codecs and protocols, may be any sort of player of media content known in the art. Player 114 may be, for example, a Windows Media Player, a Quick Time player, a RealNetworks player, a picture viewer, a browser, or any other sort of application or service capable of rendering received content, skins, user controls or user control configurations, and/or advertisements. In one embodiment, a portion of mobile client device 110 may be part of player 114 (e.g., a plug-in for player 114). The parameters may be related to various player formats and/or capabilities that may influence a customization of skins, user controls and advertisements in a graphical user interface. The parameters may also be based on information about capabilities of mobile client device 110, such as e.g., processor speed display capabilities, etc.

For the embodiments, after receiving the flow of information 1, service provider 106 may store the information and then modify (or add to) the received information based on additional parameters associated with the communication infrastructure. The information associated with the communication infrastructure may be related to, but not limited to, network conditions as well as mobile client device capabilities. Thus, in one embodiment, the content provider 102 may receive information related to Dynamic Bit-rate Adaptation (DBA), phone database, and/or Session Description Protocol/Real Time Streaming Protocols (SDP/RTSP) protocols specific to a communication service being provided to mobile client device 110. The service provider 106 may then transmit the modified (or unmodified, in some cases) information via flow of information 2 to content provider 102. The content provider 102 may use such information to customize a graphical user interface or assemble potential graphical user interface characteristics of the player based at least in part on information associated with the communication infrastructure. For example, if content provider 102 receives information from service provider 106, via flow of information 2, conveying that mobile client device 110 is associated with a higher speed processor and higher speed connection, content provider 102 may customize a graphical user interface to be transmitted to the mobile client device 110 by selecting a higher resolution advertisement, with what is considered “high” or “higher” varying from embodiment to embodiment. In contrast, if mobile client device 110 has a lower processor speed or a lower speed connection, then content provider 102 may select a low resolution advertisement with what is considered “low” or “lower” varying from embodiment to embodiment.

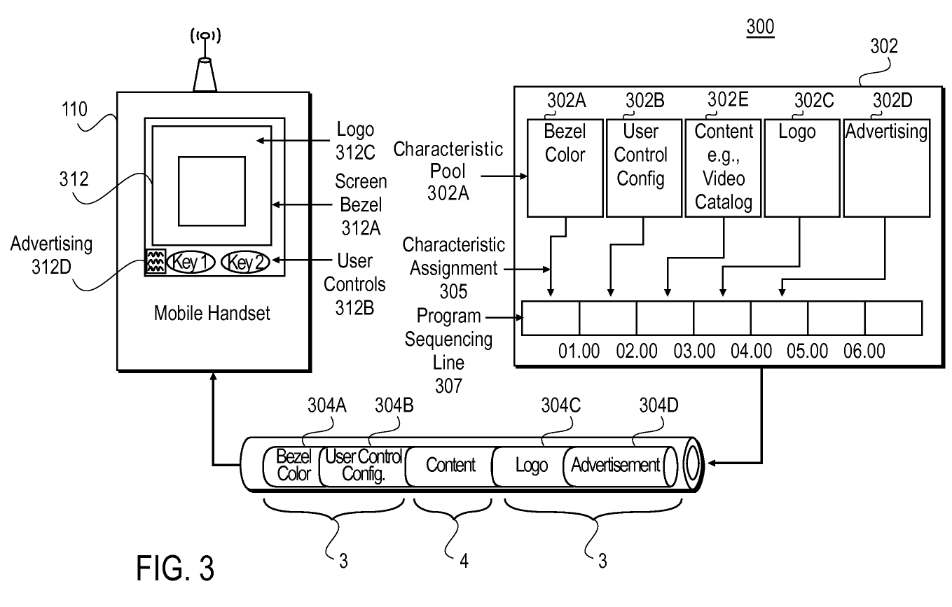

Accordingly, content provider 102 may transmit a customized graphical user interface to mobile client device 110. Or, alternately, as discussed above content provider 102 may transmit graphical user interface characteristics 3 to mobile client device 110, for mobile client device 110 to customize. At a similar time (or a different time), content provider 102 also transmits content 4 to player 114. As shown in FIG. 2, in various embodiments, the flows of graphical user interface characteristics 3 and content 4 may be separate or interleaved. As shown in FIG. 1, mobile client device 110 includes a communications interface 111 to receive the content 4 and the graphical user interface characteristics 3. In an embodiment, mobile client device 110 may include a customizing logic such as customizing logic 115 configured to customize the graphical user interface, based at least in part on the received content 4. As will be discussed further with respect to FIG. 3 below, the customization logic may be configured to analyze the content, generate a plurality of descriptors 215 about the content based on said analysis, and apply a plurality of customization rules to customize the graphical user interface based at least in part on the generated descriptors. The player 114 may then present the content using the customized graphical user interface.

Note that in alternate embodiments, service provider 106, rather than content provider 102, may provide and customize some or all of a graphical user interface or graphical user interface characteristics. In one embodiment, the graphical user interface or graphical user interface characteristics may be transmitted to content provider 102 accordingly with graphical user interface characteristics 3 or returned directly to mobile client device 110 (not shown).

To further illustrate, FIG. 3 illustrates the flow of graphical user interface characteristics 3 and content 4 from a content provider system 302 of content provider 102 to mobile client device 110 in an embodiment. Note that in FIG. 3, graphical user interface characteristics 3 and content 4 are part of a same flow to be received by mobile client device 110. In the embodiment shown, content provider system 302 includes a production tool to assist in assembling and/or producing graphical user interface characteristics 3 and content 4 to be transmitted to mobile client device 110, Graphical user interface 312, which is rendered on mobile client device 110, includes characteristics 304A-304D, such as for example, bezel color 304A, user control configuration 304B, logo 304C, and advertisement 304D which correspond to respective display screen elements of graphical user interface 312 rendered on mobile client device 110 such as, screen bezel 312A, user controls 312B, logo 312C, and advertisement 312D. As seen in FIG. 3, each of a plurality of characteristic assignment arrows 305 indicates a flow from each of a plurality of characteristic pools 302A-302D to a respective location on a program sequencing line 307. Thus, content provider system 302 may assign one or more characteristics to the display screen elements of graphical user interface 312 from the respective characteristic pools 302A-302D. Content 4, e.g. a video requested by mobile client device 110 may be assigned from a content pool 302E.

Accordingly, for the embodiment, examples of characteristics that may be customized include colors, advertising, watermark logos, user control configurations, skins, or particular layouts of the same. In various embodiments, display screen element advertisement 304D may be any sort of video, audio, audiovisual, graphic, or textual advertisement or promotion which may be incorporated with the graphical user interface 312. In an embodiment, mobile client device 110 may customize a display screen element, such as advertisement 304D, by accessing the display screen element from local storage and/or receiving updates to the display screen element, from content provider 102 or service provider 106.

Note that in various embodiments, a skin may include, for example, display screen elements accompanying content 306. A skin may include a particular selection of e.g., a particular color (or other attribute such as pattern, mark (e.g., logo), etc.) of screen bezel 312A or other display screen elements, in order to achieve a particular “look and feel.” Thus, a customization of a skin may include the selection of a particular skin or it may include the customization of particular display screen elements within a particular skin. Some skins may also include framing characteristics (i.e., content to be displayed full screen, split screen, partial screen) and branding, such as indications of one or more of a content owner (or content aggregator, mobile operator, channel, program, etc.), a content type, a rating, etc., and advertising or service sponsorship (not shown). A particular user control configuration might be included in a skin and include a particular location or other specific layout configuration such as the location of a particular menu bar, size, or other attribute of e.g. a user control such as a soft key on the graphical user interface 312. Another example of a configuration of user controls 312B may include designations for displayed text or icons (e.g. assigning an icon to a hotlink).

As discussed above, in an embodiment, mobile client device 110 may receive content from a content provider 102, and then adapt or customize the graphical user interface 312 based at least in part on the content received. Thus, in an embodiment, client device 110 may receive content 4, analyze the content 4, and generate a plurality of descriptors (e.g. descriptors 215 of FIG. 2) about the content 4 based on the analysis. Such descriptors may comprise triggers that, when detected, cause mobile client device 110 to perform one or more customizations as discussed above. Exemplary descriptors may include a content type, a content owner, or other content metadata, such as duration, performers, themes, etc. They may also include a content playlist ordering, or content localization, such as content origination, content language, or the like. In some embodiments, rather than generating the descriptors itself, mobile client device 110 may receive descriptors from content provider 102 or even service provider 106. In some embodiments, mobile client device 110 may receive the descriptors as a separate stream from the content 306. In other embodiments, the descriptors may be interleaved with the content 306 as, for example, a header or other banner portion, a watermark, or appended or pre-pended clip.

Having generated the descriptors, mobile client device 110 may customize the graphical user interface 312 based on the descriptors. In one embodiment, customizing the graphical user interface 312 based on the descriptors may comprise applying a plurality of customization rules, the customization rules specifying certain customizations to be made by the mobile client device 110. The customization rules may be a stored at mobile client device 110 and then accessed from a local storage of the mobile client device 110, and may be updated from time to time, or may be received from the content provider 102 or service provider 106 with the content 306. For example, a customization rule may specify that when the content 306 is associated with a particular video type (e.g., WMV, MPEG, etc.), the content 306 may change from the layout as shown in FIG. 3 to be displayed in a split screen mode with advertising 312E shown in another portion of the screen (either by itself or overlaying the content or advertisement). This example is simply provided for the sake of illustration. It will be appreciated by those of ordinary skill in the art that a wide variety of other exemplary customizations are possible.

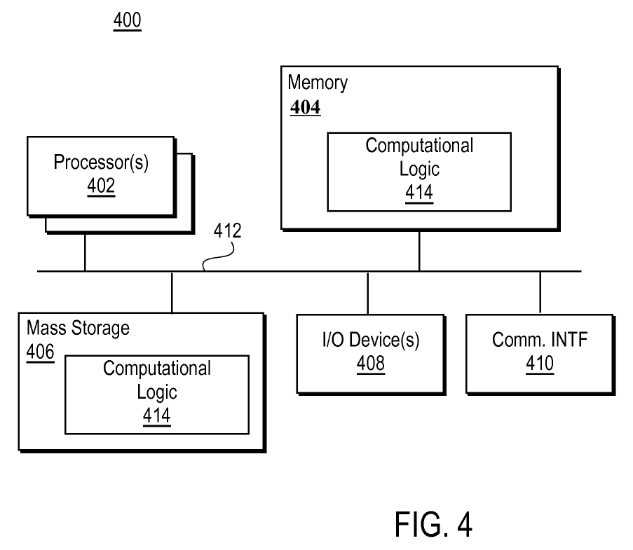

FIG. 4 illustrates an exemplary content provider server 400, in accordance with various embodiments of the invention. As shown, content provider server 400 may be a computing system/device and include one or more processors 402, and system memory 404. Additionally, content provider server 400 may include mass storage medium or devices 406 (such as diskette, hard drive, CDROM and so forth), input/output devices 408 (such as a headset or other peripheral devices) and communication interfaces 410. The elements may be coupled to each other via system bus 412, which represents one or more buses. In the case of multiple buses, they may be bridged by one or more bus bridges (not shown).

System memory 404 and mass storage 406 may be employed to store a working copy and a permanent copy of the programming instructions implementing one or more aspects of the above described teachings to practice the present invention, such as computational logic 414. The programming instructions may be implemented in assembler instructions supported by processor(s) 402 or high level languages, such as C, that may be compiled into such instructions. The permanent copy of the programming instructions may be placed into permanent storage 406 in the factory, or in the field, through e.g. a distribution medium (not shown) or through communication interfaces 410 (from a distribution server (not shown)).

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A method comprising;
receiving content by a mobile client device having a player and a graphical end user interface associated with the player;
customizing the graphical end user interface by the mobile client device, based at least in part on the content; and
presenting the content by the player of mobile client device using the customized graphical end user interface.

2. The method of claim 1, wherein the receiving comprises receiving content from a provider of the content via a selected one of an access point or a base station.

3. The method of claim 1, wherein the receiving comprises receiving a selected one of a video content, an audio content or a multi-media content.

4. The method of claim 1, wherein the customizing comprises
analyzing the content;
generating a plurality of descriptors about the content based on said analysis; and
applying a plurality of customization rules to customize the graphical end user interface based at least in part on the generated descriptors.

5. The method of claim 4 wherein the generating the plurality of descriptors about the content includes generating at least one of a content type or content metadata such as but not limited to a specific performer, type of performer, content owner or theme.

6. The method of claim 4 wherein said applying comprises accessing the plurality of customization rules from local storage of the mobile client device, and the method further comprises receiving said customization rules or updates to said customization rules.

7. The method of claim 1 wherein the customizing comprises customizing user controls of the graphical end user interface.

8. The method of claim 1 wherein the customizing comprises customizing advertisements incorporated with the graphical end user interface.

9. The method of claim 7 wherein said customizing comprises accessing the advertisements from local storage of the mobile client device, and the method further comprises receiving said advertisements or updates to said advertisements.

10. A client device comprising;
a communication interface configured to receive content;
a media player configured to present content;
a graphical end user interface associated with the player; and
customizing logic configured to customize the graphical end user interface associated with the player based at least in part on the received content.

11. The client device of claim 10, wherein the communication interface is configured to receive the content from a provider of the content via a selected one of an access point or a base station.

12. The client device of claim 10, wherein the customization logic is configured to
analyze the content;
generate a plurality of descriptors about the content based on said analysis; and
applying a plurality of customization rules to customize the graphical end user interface based at least in part on the generated descriptors.

13. The client device of claim 12 wherein the generating the plurality of descriptors about the content based on said analysis comprises generating a content playlist ordering or a content localization such as content origination or content language.

14. The client device of claim 12 further comprising a local storage configured to receive and store the customization rules.

15. The client device of claim 10 wherein the customization logic is configured to customize advertisements incorporated with the graphical end user interface.

16. The client device of claim 12 further comprising a local storage configured to receive and store the advertisements.

17. A method comprising;
receiving by a content provider, a request for content from a mobile client device communicatively coupled to the content provider via a communication infrastructure, wherein the content has an associated graphical end user interface;
receiving by the content provider information associated with the communication infrastructure;
customizing the graphical end user interface by the content provider, based at least in part information associated with the communication infrastructure; and
transmitting the content along with customized graphical end user interface to the mobile client device for presentation by the mobile client device.

18. The method of claim 17, wherein the receiving of information associated with the communication infrastructure comprises receiving information related to Dynamic Bit-rate Adaptation (DBA), phone database, and/or Session Description Protocol/Real Time Streaming Protocols (SDP/RTSP) protocols associated with a service being provided to mobile client device.

19. The method of claim 17, wherein the receiving of information associated with the communication infrastructure comprises receiving the information from a service provider providing communication service to the mobile client device.

20. The method of claim 17, wherein the content comprises a selected one of a video content, an audio content or a multi-media content.

21. The method of claim 17, wherein the customizing comprises customizing user controls of the graphical end user interface.

22. The method of claim 17, wherein the customizing comprises customizing advertisements incorporated with the graphical end user interface.

23. The method of claim 17, wherein the transmitting comprises transmitting the content and the customized graphical end user interface to the mobile client device via a service provider providing communication service to the mobile client device.

24. An apparatus comprising;
a processor; and
storage medium coupled to the processor, the storage medium having stored therein instructions to be executed by the processor, wherein when executed, the instructions enable the apparatus to
receive a request for content from a mobile client device communicatively coupled to the apparatus via a communication infrastructure, wherein the content has an associated graphical end user interface,
receive information associated with the communication infrastructure,
customize the graphical end user interface, based at least in part information associated with the communication infrastructure, and
transmit the content along with customized graphical end user interface to the mobile client device for presentation by the mobile client device.

25. The apparatus of claim 24, wherein the instructions are configured to enable the apparatus to receive information related to Dynamic Bit-rate Adaptation (DBA), phone database, and/or Session Description Protocol/Real Time Streaming Protocols (SDP/RTSP) protocols associated with a communication service being provided to mobile client device.

26. The apparatus of claim 24, wherein the instructions are configured to enable the apparatus to receive the information associated with the communication infrastructure from a service provider providing communication service to the mobile client device.

27. The apparatus of claim 24, wherein the instructions are configured to enable the apparatus to customize advertisements incorporated with the graphical end user interface.

28. The apparatus of claim 24, wherein the instructions are configured to enable the apparatus to transmit the content and the customized graphical end user interface to the mobile client device via a service provider providing communication service to the mobile client device.

29. The apparatus of claim 24, wherein the instructions are configured to enable the apparatus to apply a customization rule specifying specific customizations to be made to a skin of the graphical end user interface.

30. The apparatus of claim 29, wherein the customization rule is triggered by a descriptor associated with the content.
